(19) United States
(12) Patent Application Publication
(10) Pub. No.: US 2010/0081306 A1
(43) Pub. Date: Apr. 1, 2010

(54) ELECTRICAL PLUG AND SOCKET ASSEMBLY

(76) Inventor: Joe Bowering, Edmonton (CA)

Correspondence Address: Intellipex PLLC, 30200 Telegraph Road, Suite 245, Bingham Farms, MI, 48025, US

(21) Appl. No.: 12/565,811

(22) Filed: Sep. 24, 2009

Related U.S. Application Data
(60) Provisional application No. 61/194,356, filed on Sep. 26, 2008.

(51) Int. Cl. H01R 13/44

(52) U.S. Cl. 439/188

(57) ABSTRACT

An electrical plug and socket assembly includes a socket and a plug. The socket includes a socket housing, a plurality of female connectors and a plurality of circuit members. Each of the plurality of circuit members having a non-conductive portion and a conductive portion slidably coupled to one of a live line and a neutral line. The plug includes a plurality of male connectors and a prong structure. The prong structure is capable of pressing the plurality of circuit members, thereby enabling the longitudinal sliding movement. Live female connector and neutral female connector are connected to the live line and the neutral line through the plurality of circuit members. Accordingly, an electrical connection of one of the live line and the neutral line with one of live female connector and neutral female connector may be controlled based upon pressing of the plurality of circuit members by the prong structure.

### CROSS REFERENCE TO RELATED APPLICATIONS

The present disclosure claims the benefit of U.S. Provisional Application No. 61/194,356 filed on Sep. 26, 2008 the disclosure of which is incorporated by reference.

### FIELD OF THE DISCLOSURE

The present disclosure relates generally to electrical plugs and sockets, and more particularly, to an electrical plug and socket assembly.

### BACKGROUND OF THE DISCLOSURE

Generally, electrical outlets, such as a socket are provided at various locations in a civil construction, such as an office complex and a residential complex to provide access points for electricity. The socket typically includes two or more slots that are internally connected to electrical lines from a mains connection. In order to access the electricity from the socket, household devices include a plug that includes two or more prongs that may be inserted in corresponding slots.

Such socket may be provided at different locations in the civil construction and any unauthorized user may plug his/her device to the sockets and access electricity to power his/her device. Due to such unauthorized access of electricity from the socket, an actual owner of the civil construction would be billed by an electricity distribution company for electricity consumed by someone else from the socket. The problem of unauthorized usage of electricity will be more severe in case the socket is positioned at an area easily accessible to the unauthorized user such as stairways, front gates and garages.

Currently, there are a few techniques known in the art for addressing the above problem of unauthorized usage of the socket. In one such technique, an enclosure is formed around the socket with an access window that may be moved between an open position and a closed position. The socket may only be accessed when the access window is in the open position. The access window may be secured with help of a key and a lock assembly when it is in the closed position. In order to open the access window, any user will need to unlock the lock assembly with its corresponding key. However, this technique has a drawback that the enclosure occupies significant space around the socket, thereby making it inconvenient for plugs to access the slots of the socket. This situation may be more severe, when multiple plugs or a multi-pin adapter is required to be plugged into the socket.

In another technique, internal connections of the slots of the socket to the mains connection may be opened and closed with help of a key operated locking mechanism. When the key is moved to an ‘on’ position, the internal connections are closed thereby powering the slots of the socket. Further, when the key is moved to an ‘off’ position, the internal connections are opened thereby blocking any electrical power supply to the slots of the socket. However, the key operated locking mechanism requires the user to carry the key of the key operated locking mechanism in order to access the socket.

### SUMMARY

In one aspect of the present disclosure, an electrical plug and socket assembly is provided. The electrical plug and socket assembly includes an electrical socket and an electrical plug. The electrical socket includes a socket housing, a plurality of female connectors and a plurality of circuit members. The socket housing is configured by an inner wall and an outer wall. The plurality of female connectors is configured between the inner wall and the outer wall having corresponding openings at the outer wall. The plurality of female connectors includes a live female connector and a neutral female connector. The live female connector is capable of being electrically connected to a live line and the neutral female connector is capable of being electrically connected to a neutral line. The plurality of circuit members is disposed between the inner wall and the outer wall for controlling electrical connection of one of the live line to the live female connector and of the neutral line to the neutral female connector. The plurality of circuit members is slidably coupled to the one of the live line and the neutral line. Each circuit member of the plurality of circuit members includes a non-conductive portion and a conductive portion along a length thereof. The conductive portion of the each circuit member is capable of being positioned at one of a plurality of pre-determined portions of length of the each circuit member. The each circuit member is capable of longitudinally moving between the inner wall and the outer wall of the socket housing such that one of conductive portions and non-conductive portions of the plurality of circuit members is connected to one of the live line and the neutral line.

The electrical plug includes a plurality of male connectors and a prong structure. The plurality of male connectors is configured on a support surface of the electrical plug. The plurality of male connectors includes a live male connector and a neutral male connector. The live male connector is capable of being inserted in the live female connector and the neutral male connector is capable of being inserted in the neutral female connector. The prong structure is configured on the support surface based on the positioning of the conductive portion on the plurality of circuit members. Each prong of the prong structure is capable of pressing a corresponding circuit member of the plurality of circuit members for facilitating the longitudinal movement of the corresponding circuit member, thereby controlling the electrical connection of one of the live line and the neutral based on connections of the conductive portions to one of the live line and the neutral line.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 illustrates a perspective view of an embodiment of an electrical plug and socket assembly; and

FIG. 2 illustrates an internal diagram of an electrical socket of the electrical plug and socket assembly of FIG. 1.

Like reference numerals refer to like parts throughout the description of several views of the drawings.

### DETAILED DESCRIPTION OF THE DISCLOSURE

The exemplary embodiments described herein provide detail for illustrative purposes, and are subject to many variations in composition, structure, and design. It should be emphasized, however, that the present disclosure is not limited to a particular electrical plug and socket assembly, as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein are for the purpose of description and should not be regarded as limiting.

Unless limited otherwise, the terms “coupled,” “attached,” and variations thereof herein are used broadly and encompass direct and indirect arrangements. The terms “a” and “an” herein do not denote a limitation of quantity, but rather denote the presence of at least one of the referenced items.

The present disclosure provides an electrical plug and socket assembly. The electrical plug and socket assembly includes an electrical socket and an electrical plug. The electrical socket includes a socket housing, a plurality of female connectors and a plurality of circuit members. The socket housing includes an inner wall and an outer wall. The plurality of female connectors is configured between the inner wall and the outer wall having corresponding openings at the outer wall. The plurality of female connectors includes a live female connector and a neutral female connector. The live female connector is capable of being electrically connected to a live line and the neutral female connector is capable of being electrically connected to a neutral line.

The plurality of circuit members is disposed between the inner wall and the outer wall for controlling electrical connection of one of the live line and the neutral line. The plurality of circuit members is slidably coupled to the one of the live line and the neutral line. Each circuit member of the plurality of circuit members includes a non-conductive portion and a conductive portion along a length thereof. The conductive portion of the each circuit member is capable of being positioned at one of a plurality of pre-determined portions of length of the each circuit member. The each circuit member is capable of a longitudinal movement between the inner wall and the outer wall of the socket housing such that one of conductive portions and non-conductive portions of the plurality of circuit members are connected to one of the live line and the neutral line.

The electrical plug includes a plurality of male connectors and a prong structure. The plurality of male connectors is configured on a support surface of the electrical plug. The plurality of male connectors includes a live male connector and a neutral male connector. The live male connector is capable of being inserted in the live female connector and the neutral male connector is capable of being inserted in the neutral female connector. The prong structure is configured on the support surface based on the positioning of the conductive portion on the plurality of circuit members. Each prong of the prong structure is capable of pressing a corresponding circuit member of the plurality of circuit members for facilitating the longitudinal movement of the corresponding circuit member, thereby controlling the electrical connection of one of the live line and the neutral line based on connection of the conductive portions to one of the live line and the neutral line.

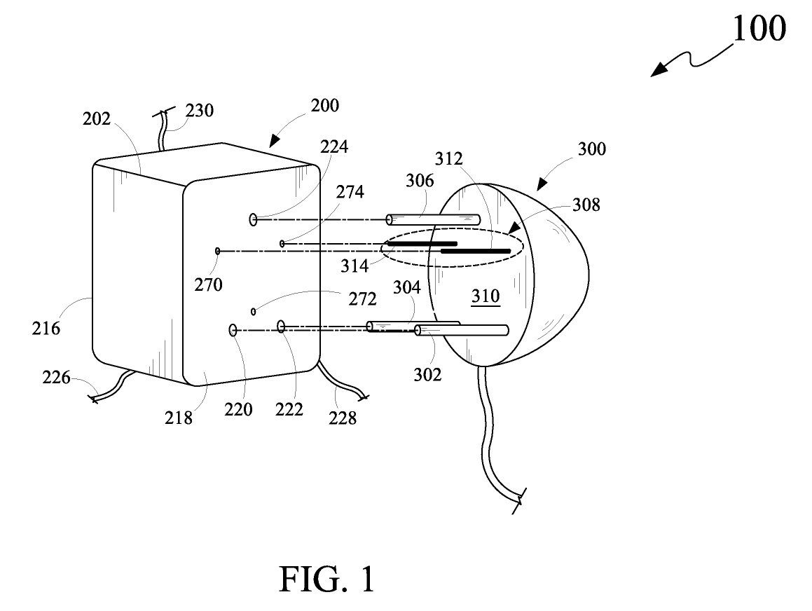

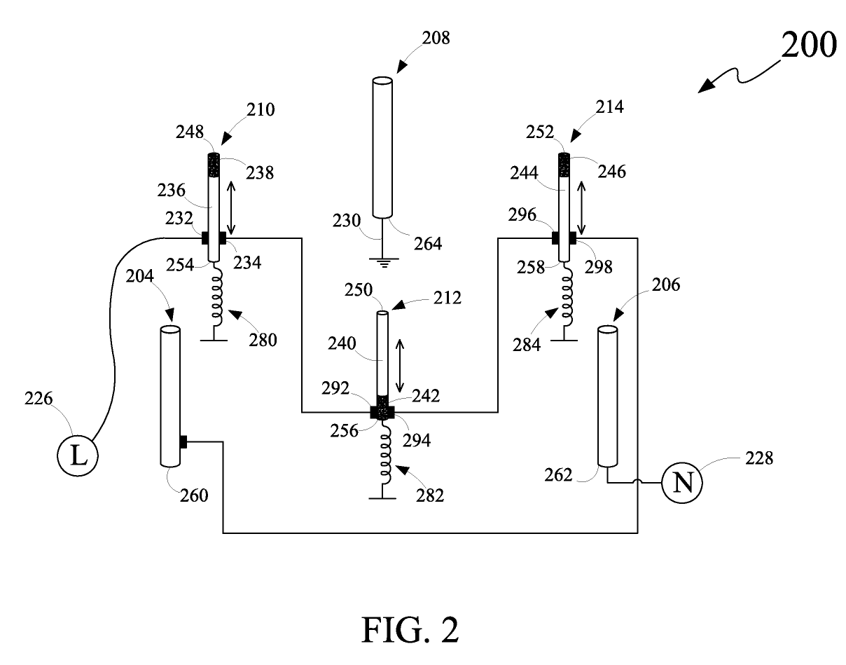

Referring to FIG. 1, a perspective view of an embodiment of an electrical plug and socket assembly 100 is illustrated. The electrical plug and socket assembly 100 includes the electrical socket 200 and an electrical plug 300. Further, referring to FIG. 2, internal diagram of one exemplary embodiment of the electrical socket 200 is illustrated.

The electrical socket 200 includes a socket housing 202. The socket housing 202 includes an inner wall 216 and an outer wall 218. In application, the socket housing 202 may be accommodated inside an electrical outlet board configured on a wall surface (not shown). The socket housing 202 is accommodated inside the electrical outlet board such that the outer wall 218 acts as a front face of the electrical socket 200 and may be accessible for the electrical plug 300.

The electrical socket 200 further includes a plurality of female connectors, such as a live female connector 204, a neutral female connector 206 and an earth female connector 208, and a plurality of circuit members, such as a circuit member 210, a circuit member 212 and a circuit member 214. The female connectors 204, 206 and 208, and the circuit members 210, 212 and 214 are configured between the inner wall 216 and the outer wall 218 of the socket housing 202, and are shown in FIG. 2.

The female connectors 204, 206 and 208 have their corresponding openings at the outer wall 218, as shown in FIG. 1. Particularly, the live female connector 204, the neutral female connector 206 and the earth female connector 208 have their corresponding openings 220, 222 and 224, respectively on the outer wall 218. Further, the female connectors 204, 206 and 208 may be supported at their ends 260, 262 and 264, respectively, on the inner wall 216. The live female connector 204 and the neutral female connector 206 are capable of being electrically connected to a live line 226 and a neutral line 228, respectively, of a mains connection. Further, in one form, the earth female connector 208 may be connected to an earthing line 230.

Further, the circuit members 210, 212 and 214 are disposed between the inner wall 216 and the outer wall 218 for controlling electrical connection of one of the live line 226 and the neutral line 228. In one form, the circuit members 210, 212 and 214 are positioned such that they may be accessed through openings 270, 272 and 274 configured on the outer wall 218. An exemplary representation of the circuit members 210, 212 and 214 is shown in the internal diagram of the electrical socket 200 in FIG. 2.

The circuit members 210, 212 and 214 may be slidably coupled to either the live line 226 or the neutral line 228. In the exemplary representation of FIG. 2, the circuit members 210, 212 and 214 are shown as slidably coupled to the live line 226 such that the circuit members 210, 212 and 214 are always in contact with the live line 226. The circuit members 210, 212 and 214 are electrically connected in a series connection with the live line 226. More specifically, the live line 226 includes contacts, such as contacts 232 and 234 that are configured to electrically connect the live line 226 to the circuit member 210 while enabling sliding of the circuit member 210, longitudinally. In one form, the circuit members 210, 212 and 214 include spring arrangements 280, 282 and 284, which upon being pressed and released, provide a longitudinal sliding movement to the circuit members 210, 212 and 214, respectively between the inner wall 216 and the outer wall 218.

As shown in FIG. 2, the circuit member 210 includes a non-conductive portion 236 and a conductive portion 238, the circuit member 212 includes a non-conductive portion 240 and a conductive portion 242 and the circuit member 214 includes a non-conductive portion 244 and a conductive portion 246. Various conductive portions 238, 242, and 246 may be composed of copper, silver, aluminum and the like. Further, the non-conductive portions 236, 240 and 244 may be composed of plastic, rubber, ceramic and the like. However, it may be apparent to a person skilled in the art that various other materials may be utilized in the composition of the conductive portions and the non-conductive portions.

The conductive portions 238, 242, and 246 of the circuit members 210, 212 and 214 may be positioned at one of a plurality of pre-determined position along the lengths of the circuit members 210, 212 and 214, respectively. For example, the conductive portion 238 may be positioned at a top portion 248 or a bottom portion 254 of the circuit member 210. Similarly, the conductive portion 242 may be positioned at either a top portion 250 or a bottom portion 256 of the circuit member 212, and the conductive portion 246 may be positioned at top portion 252 and a bottom portion 258 of the circuit member 214. The longitudinal movement of the circuit members 210, 212 and 214 between the inner wall 216 and the outer wall 218 may enable either the conductive portions 238, 242, and 246 or the non-conductive portions 236, 240 and 244 to be connected to the live line 226.

For example, contacts 232 and 234 of the live line 226 are in contact with the non-conductive portion 236 of the circuit member 210, as shown in FIG. 2. Further, the circuit member 210 may be pressed downwardly at the top portion 248 for compressing the spring arrangement 280 and in turn the conductive portion 238 may come in contact with the contacts 232 and 234 of the live line 226. Further, contacts 292 and 294 of the live line 226 are already in contact with the conductive portion 242 of the circuit member 212. Furthermore, the circuit member 214 may also be pressed downwardly at the top portion 252 for compressing the spring arrangement 284 and in turn the conductive portion 246 may come in contact with the contacts 296 and 298 of the live line 226. The live line 226 is further connected to the live female connector 204. Accordingly, it will be apparent to those skilled in the art that the live female connector 204 will only receive electrical power when the conductive portions 238, 242 and 246 are in contact with the live line 226. Accordingly, the electrical connection of the live line 226 and the live female connector 204 may be controlled (make or brake) based on the physical contact of the conductive portions 238, 242, and 246 to the live line 226 upon suitable longitudinal movement of the circuit members 210, 212 and 214. The present disclosure provides the electrical plug 300, which may be specially designed according to the arrangement of the circuit members 210, 212 and 214 such that the electrical plug 300 may be used to access power from the electrical socket 200.

The electrical plug 300 includes a plurality of male connectors such as a live male connector 302, a neutral male connector 304 and an earth male connector 306, and a prong structure 308. The plurality of male connectors is configured on a support surface 310 of the electrical plug 300 (as shown in FIG. 1). In one form, the plurality of male connectors may be cylindrical in shape. Accordingly, the plurality of female connectors is tubular in shape (shown in FIG. 2) to accommodate the insertion of the plurality of female connectors. Of course, the plurality of male connectors may be of various other shapes depending upon shapes of the female connectors. The plurality of male connectors is composed of a conductive material so that they can conduct electrical power upon insertion inside the plurality of female connectors. Examples of conductive material may include copper, aluminum, silver and the like. However it may be apparent to a person skilled in the art that various other materials may be utilized in the composition of the plurality of male connectors.

Referring again to FIG. 1, it is apparent that the live male connector 302 is capable of being inserted in the live female connector 204 through the opening 220. Similarly, the neutral male connector 304 is capable of being inserted in the neutral female connector 206 through the opening 222. Further, the earth male connector 306 is capable of being inserted in the earth female connector 208 through the opening 224. Insertion of the plurality of male connector in the plurality of female connectors electrically couples the live male connector 302, neutral male connector 304 and the earth male connector 306 to the live line 226, the neutral line 228 and the earthing line 230, respectively.

As disclosed earlier, the live line 226 will be connected to the live female connector 204 when conductive portions 238, 242, and 246 of the circuit members 210, 212, and 214 are connected to the live line 226. Accordingly, the prong structure 308 is configured on the support surface 310 based on the arrangement of the circuit members 210, 212, and 214. Specifically, the prong structure 308 may include one or more prongs, such as a prong 312 and a prong 314 that are positioned on the support surface 310 such that, the one or more prongs are capable of pressing circuit members having conductive portions configured on their top portions. For example, the circuit members 210 and 214 have their corresponding conductive portions 238 and 246 on the top portions 248 and 252, respectively. Accordingly, the prong 312 and the prong 314 are configured on the support surface 310 such that when the electrical plug 300 is inserted inside the electrical socket 200, the prong 312 and the prong 314 press the circuit member 210 and the circuit member 214 towards the inner wall 216. The pressing of the circuit member 210 and the circuit member 214 caused the conductive portions 238 and 246 to come in physical contact with the live line 226. More specifically, the conductive portion 238 comes into physical contact with the contacts 232 and 234 of the live line 226. Similarly, the conductive portion 246 comes into physical contact with the contacts 296 and 298 of the live line 226. Further, as the conductive portion 242 is already connected to the contacts 292 and 294 of the live line 226, accordingly the prong structure 308 does not include any corresponding prong for the circuit member 212.

It will be apparent to those skilled in the art that by the insertion of the electrical plug 300 into the electrical socket 200, the live line 226 is connected to the live female connector 204 and thereby electrical power may be conducted to the electrical plug. It will further be apparent to those skilled in the art that if any ordinary electrical plug without having any especially designed prong structure similar to the prong structure 308 is inserted into the electrical socket 200, will be unable to draw electrical power from the electrical socket 200. Further, the prong structure 308 and the circuit members 210, 212 and 214 may be mutually configured in plurality of combinations. Furthermore, the number of circuit members and prong structure may also vary from that shown in FIGS. 1 and 2. Accordingly, the electrical plug and socket assembly 100 may act as a coded electrical plug. Further, a security level for any unauthorized access of the electrical socket 300 may be increased with more number of circuit members and corresponding prongs. For example, for n (n being positive integral number) different circuit members, 2ⁿ number of different positioning arrangements of conductive portions of the circuit members are possible.

Accordingly, the present disclosure provides a coded electrical plug and socket assembly, such as the electrical plug and socket assembly 100 that is advantageous in restricting unauthorized usage of the electrical socket 200. Further, the security level for the unauthorized access of the electrical socket 200 may be varied depending upon the number of circuit members. The coded electrical plug and socket assembly does not require an additional key-and-lock assembly for securing the electrical socket 200. This enables the coded electrical plug and socket assembly to be used independent of additional components. Specifically, a user does not need to carry a key for accessing the electrical socket 200, the prong structure 308 of the electrical plug 300 acts as a key for accessing the electrical socket 200.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present disclosure.

What is claimed is:

1. An electrical plug and socket assembly, the electrical plug and socket assembly comprising:
an electrical socket including,
a socket housing having an inner wall and an outer wall,
a plurality of female connectors configured between the inner wall and the outer wall having corresponding openings at the outer wall, the plurality of female connectors comprising a live female connector and a neutral female connector, the live female connector capable of being electrically connected to a live line and the neutral female connector capable of being electrically connected to a neutral line, and
a plurality of circuit members disposed between the inner wall and the outer wall for controlling electrical connection of one of the live line to the live female connector and of the neutral line to the neutral female connector, the plurality of circuit members slidably coupled to the one of the live line and the neutral line, each circuit member of the plurality of circuit members comprising a non-conductive portion and a conductive portion along a length thereof, wherein the conductive portion of the each circuit member is capable of being positioned at one of a plurality of pre-determined portions of length of the each circuit member, wherein the each circuit member is capable of longitudinally moving between the inner wall and the outer wall of the socket housing such that one of conductive portions and non-conductive portions of the plurality of circuit members is connected to one of the live line and the neutral line; and
an electrical plug comprising,
a plurality of male connectors configured on a support surface of the electrical plug, the plurality of male connectors comprising a live male connector and a neutral male connector, the live male connector capable of being inserted in the live female connector and the neutral male connector capable of being inserted in the neutral female connector, and
a prong structure including one or more prongs and configured on the support surface based on the positioning of the conductive portions on the plurality of circuit members, each prong of the one or more prongs capable of pressing a corresponding circuit member of the plurality of circuit members for facilitating the longitudinal movement of the corresponding circuit member between the inner wall and the outer wall, thereby controlling the electrical connection of the one of the live line and the neutral based on connection of the conductive portions to the one of the live line and the neutral line.

2. The electrical plug and socket assembly of claim 1, wherein the each circuit member comprises a spring arrangement attached at a bottom portion thereof, the spring arrangement capable of providing the longitudinal movement to the each circuit member upon being pressed at a top portion of the each circuit member towards the inner wall.

3. The electrical plug and socket assembly of claim 1, wherein the plurality of female connectors further comprises an earth female connector.

4. The electrical plug and socket assembly of claim 1, wherein the plurality of male connectors further comprises an earth male connector.

5. The electrical plug and socket assembly of claim 1, wherein the plurality of pre-determined portions comprises a top portion and a bottom portion of the each circuit member.
